(19) United States
(12) Patent Application Publication
(10) Pub. No.: US 2021/0256621 A1
(43) Pub. Date: Aug. 19, 2021

(54) SYSTEM FOR DATA AGGREGATION

(71) Applicant: Broker Insights Limited, Dundee (GB)

(72) Inventors: Fraser Matthew Edmond, Dundee (GB); Iain David Crole, Perth (GB)

(21) Appl. No.: 17/251,555

(22) PCT Filed: Jun. 24, 2019
(86) PCT No.: PCT/GB2019/000088

§ 371 Date: Dec. 11, 2020

Related U.S. Application Data
(60) Provisional application No. 62/689,560, filed on Jun. 25, 2018.

(51) Int. Cl. G06Q 40/08; G06F 21/62; G06F 16/27; G06F 16/25

(52) U.S. Cl. CPC G06Q 40/08; G06F 16/252; G06F 16/27; G06F 21/6254

(57) ABSTRACT

A computer implemented system and method which allows an insurer to more effectively target business development activities towards independent insurance brokers. The system has a data ingestion system for securely receiving agent data from an agent system and aggregating the agent data into one or more database entry. The agent data comprises agent client data and agent identification data and the agent client data is masked such that specific agent client data is absent from or obscured in the database entry. A user database is provided for receiving the database entry as is a user interface.

### INTRODUCTION

The present invention relates to a system for data aggregation and in particular a system for data aggregation for use in the insurance industry.

### BACKGROUND TO THE INVENTION

Insurance may be defined as a means of protection from financial loss. An entity which provides insurance is known as an insurer, insurance company, insurance carrier or underwriter. A person or entity who buys insurance is known as an insured or policyholder. The insurance transaction involves the insured assuming a guaranteed and known relatively small loss in the form of payment to the insurer in exchange for the insurer's promise to compensate the insured in the event of a covered loss. The loss may or may not be financial, but it must be reducible to financial terms, and usually involves something in which the insured has an insurable interest established by ownership, possession, or pre-existing relationship.

The insured receives a contract, called the insurance policy, which details the conditions and circumstances under which the insurer will compensate the insured. The amount of money charged by the insurer to the insured for the coverage set forth in the insurance policy is called the premium. If the insured experiences a loss which is potentially covered by the insurance policy, the insured submits a claim to the insurer for processing by a claims adjuster. The insurer may hedge its own risk by taking out reinsurance, whereby another insurance company agrees to carry some of the risk, especially if the risk is too large for the primary insurer to carry.

An insurance broker (also insurance agent) sells, solicits, or negotiates insurance for compensation. General insurance brokering is carried out by many types of authorized organisations including traditional high street brokers.

The relationship between the insurer and the broker is one whereby the broker acts as an intermediary between the insurer and the insured. The broker is agent of the customer, understanding the customers' needs, their experience and their risks and management of these. It is then the brokers role to source the best insurance product for his customer by searching the insurance market. This requires the selection of the best product, service and price for his customer. Typically, the broker will provide insurance products across a wide range of sectors such as professional indemnity, property, engineering, marine and public liability, to a network of customers who are local to the broker. The insurance products are created by the insurer and provided to the insured customer by the broker who will have relationships with several insurers. In 2018, the UK commercial insurance market served by brokers had an annual revenue of £16 bn.

In the above, well established business model, it is crucial for an insurer that they develop a good working relationship with a broker, so that the broker understand the insurers capabilities and the insurer develops knowledge of the types of customers and risks the broker manages and when the broker is looking to obtain insurance for its clients. Currently, an insurer will focus this type of business development on traditional sales techniques such as telephone sales and ‘on the road’ sales agents that contact brokers to identify the available business. This situation is partly due to the fragmented nature of the market, with thousands of brokers from small to very large. It is also due to the complex nature of the insurance product, where a commercial customer could have multiple businesses with multiple sites and each needing multiple insurance products. This results in tailored offerings to customers with the broker playing a key role in advising the customer of their needs.

One barrier to the use of digital services to support business development is the competing requirements to create technology that can provide useful information to the insurer about the activities and requirements of a broker whilst ensuring that each broker's data remains confidential.

### SUMMARY OF THE INVENTION

It is an object of the present invention to provide a computer implemented system and method which allows an insurer to more effectively target business development activities towards independent insurance brokers.

In accordance with a first aspect of the invention there is provided a computer implemented system for providing information to an end user, the system comprising:
a data ingestion system for securely receiving agent data from an agent system and aggregating the agent data into one or more database entry, the agent data comprising agent client data and agent identification data wherein agent client data is masked such that specific agent client data is absent from or obscured in the database entry;
a user database for receiving the database entry;
and a user interface.

In accordance with a second aspect of the invention there is provided a computer implemented method for providing information to an end user, the method comprising the steps:
securely receiving agent data from an agent system;
aggregating the agent data into one or more database entry, the agent data comprising agent client data and agent identification data wherein agent client data is masked such that specific agent client data is absent from or obscured in the database entry;
Providing the database entry to a user interface of a user database.

Preferably, the system further comprises a communication means to allow communication from the user to the agent system.

Preferably, the communications means comprises a feature on the user interface which is actionable by the user to create a message to the agent. Optionally, the message is a text message, multimedia message, email or the like.

Preferably, the agent is an insurance broker.

Preferably, the client is a customer of the insurance broker

Preferably the user is an insurer.

Preferably, the agent system is an insurance broker's customer management system.

Preferably, the agent client data comprises a database entry per agent client matter.

Preferably, the agent client data is masked by retaining agent identification data is retained in the data ingestion system.

Preferably, the data ingestion system standardizes the agent data.

Preferably, the data ingestion system logs agent client data received so as to separately identify the agent client matters contained in the agent client data.

Preferably, the data ingestion process records changes to the database which occur during data ingestion. The result of the ongoing ingestion of data files is the aggregated data in the database.

Preferably, the agent data is received as encrypted data.

Preferably, the agent data is received upon the action of a data verification step initiated by the agent system

Preferably, the user database comprises a MySQL relational database.

Preferably, the system further comprises a secondary database which is a mirror image of the primary database.

Preferably, the secondary database reflects any changes to the primary database due to data ingestion or user input.

Preferably, the user interface comprises a plurality of selectable data views.

Preferably, the user interface is configured to be viewable on a mobile computing device such as a smartphone.

Preferably, the user interface is configured to be viewable on a tablet computing device.

Preferably, the user interface is configured to be viewable on a laptop or desktop computer.

Preferably, marketing information is uploadable to the system by one or more agent and the user may select can choose an agent based upon the message content wherein said marketing information is pushed to chosen user targets.

Preferably, the system further comprises a predictive software application which matches agents with users based on one or more criteria.

Preferably, the predictive software application extracts policy information from one or more database entry; separates the information into policy information from partner agents and non-partner agents, categorises the partner agent policy information based on a range of criteria; compares the categorised partner agent information with the non-partner information to determine the similarity between the partner information and the non-partner information.

### BRIEF DESCRIPTION OF THE DRAWINGS

The present invention will now be described with reference to the accompanying drawings in which:

FIG. 1 is a block diagram which shows an embodiment of a computer implemented system in accordance with the present invention;

FIG. 2 is a schematic diagram which shows another embodiment of a computer implemented system in accordance with the present invention;

FIG. 3 is a screen shot which shows the ‘My Leads’ search facility from a user interface provided to an insurer in an example of the present invention;

FIG. 4 is a screen shot which also shows the ‘My Leads’ search facility from a user interface provided to an insurer in an example of the present invention;

FIG. 6 is a screen shot which shows the ‘My Stats’ screen from a user interface provided to an insurer in an example of the present invention;

FIG. 7 is a screen shot which shows the ‘Stats’ screen from a user interface provided to an insurer in an example of the present invention;

FIG. 8 is a screen shot which shows the ‘My Broker’ screen from a user interface provided to a broker in an example of the present invention;

FIG. 9 is a screen shot which shows the ‘My Policies’ screen from a user interface provided to a broker in an example of the present invention;

FIG. 10 is a schematic diagram which shows the targeting of marketing data to brokers by insurers; and

FIG. 11 is a schematic diagram which shows the predictive matching of brokers, insurers and customers.

The present invention provides a computer implemented system and method for providing information to an end user.

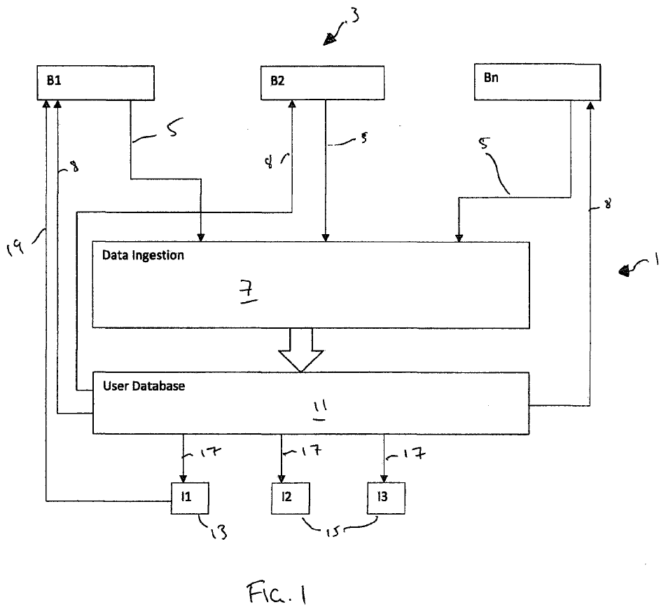

FIG. 1 shows a computer implemented system 1 for providing information to an end user. In this example, agent systems 3 are shown as B1 to Bn. Data is securely extracted 5 from each agent system 3 to a data ingestion system 7. The extracted data is aggregated in one or more database entry and includes agent client data and agent identification data. The agent client data is masked such that specific agent client data is absent from or obscured in the data which is uploaded to the user database 11. Data displayed to insurers or brokers always comes from the database

Typically, data is contained in a relational database. It will be appreciated that a large number of client matters from a large number of agents will be viewable by a user. The data will be masked to prevent the user 13, 15 gaining access to client confidential and/or commercially sensitive information. If the example of user 13 is considered; the user may have spent time conducting searches 17 on the database and may wish to contact the agent which is the owner of the data in which the user 13 has an interest.

In that case, the user 13 will contact 19 the agent to discuss opportunities shown in the database. In addition, the broker 5 is connected 8 to the database 11 to view their data on the user database 11.

In another example, the system of the present invention includes a messaging application which allows the user to contact the agent using the agent's graphical user interface. This functionality may be provided by a button on the user interface which the user 13 can activate to send the agent 13 a message via text, email or other messaging service.

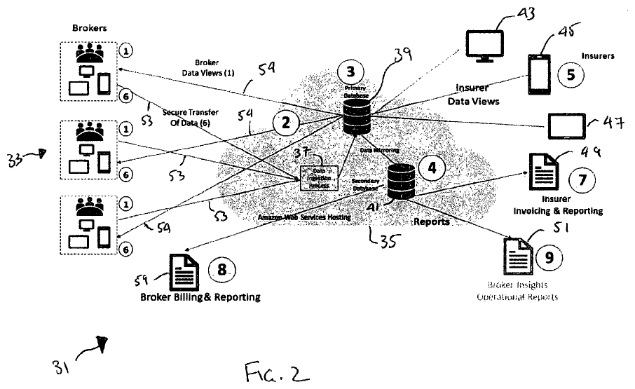

Another example of the present invention is described below with reference to FIGS. 2 to 9 and relates to the activities of insurers and insurance brokers. The present invention provides insurers with the ability to identify business opportunities through a database system whilst maintaining the confidentiality of the brokers' client records and in at least one embodiment of the invention, enquire about business opportunities in a manner that masks or obfuscates client data to the insurer, but identifies the client to the broker system, based upon the insurer's query.

FIG. 2 shows an example of a system 31 in accordance with the present invention. The figure shows insurance broker management systems 33, databases 39, 41 and a data ingestion process 37 hosted on a cloud 35. The users are insurers and the user interface may be viewed on a number of different computing device types such as a desktop computer 43, mobile device 45 or tablet 47. The system as shown in FIG. 2 may generate insurers' reports 49, system reports 51 and broker reports 59.

In this example of the invention, data is extracted 53 from the brokers' customer management systems on a weekly basis into a csv format file (comma separated values) and transferred securely using HTTPS SSL (Hyper Text Transfer Protocol Secure: Secure Sockets Layer) encryption. The data extracted includes policy details, product categories, company/customer information and associated administration information. A check is carried out by the transfer process to ensure that the file is in csv format and gives an error message if not. The file field names are also checked to ensure that the required fields are present.

Two of the key objectives are to ensure the security of the brokers' data and to make the process as easy as possible for the brokers. Data security is a major concern for brokers as a competitor obtaining access to their data could damage their business and reputation. The present invention incorporates data security measures throughout the system.

Once the extract file has been created, a broker representative will use a ‘Send Report’ screen to drag the csv file on to a transfer area in the centre of the screen, and the file will be securely transferred to the system hosted in Amazon Web Services (AWS).

The data received is structured in such a way that the broker can fully audit their processes. Changes to the data are individually itemised and thus reflected in the data extract e.g. negative premiums reflect cancellations or changes in a policy. This means that there can be multiple rows per policy, which need to be harmonised into a single row when compiled in the user/insurer database.

The ingestion process 37 initially reads the csv files into temporary memory. All the data is then written to a policy archive table for audit and problem resolution purposes. Data is then prepared by inputting missing data and standardising where possible e.g. aligning product details to the platform categorisation. The data is then reshaped so that every row reflects a particular policy for each relevant year. Rows will be combined if they are for the same policy; or removed if key data is missing or invalid; or if the data is not relevant, for example, if the renewal is in the past. The process will band the premiums to mask or obfuscate the broker's revenue information.

A log is kept of every policy that has gone through the process, which identifies renewal scenarios on subsequent processes. All policies that have passed all checks are put into a temporary ‘policy pending’ table ready for insertion into the main policy table.

An activation process is then performed which ensures that the insurer and product category are legitimate. The policy data is then inserted into the policy table in the database. In this example of the present invention, the primary database 39 is a MySQL relational database that holds all the ingested/aggregated data. The database is designed to support two key requirements:
a) The functionality required of the system through data relationships; and
   b) The performance of the user screens (i.e. suitable response times for queries) and additional behaviour information for product development purposes.

The secondary database 41 is a mirror image of the primary database 39. Any changes to the primary database due to data ingestion or user input are reflected in the secondary database in real time. The secondary database 41 is available immediately if there is a critical failure in the primary database 39 that would result in a loss of service. If this occurred, the online system would switch over to using the secondary database 41, thus limiting any outage for the users. As the secondary database 41 is identical to the primary database 39, reporting can be run against the secondary database 41 to remove any potential performance conflict with users that are accessing the primary database 39.

Insurer users will be able to access the platform functionality using PCs/laptops 43, tablets 47 and phones 45. The platform will be available for use on iPhone and Android phones as well as all the main browsers. Users will log in using their email address and password. Brokers are able to identify specific customers and policies when contacted by the insurer. The contact may be via a messaging system which is built into the system of the present invention. In addition, the broker 33 is connected 54 to the database 39 to view their data on the user database 39.

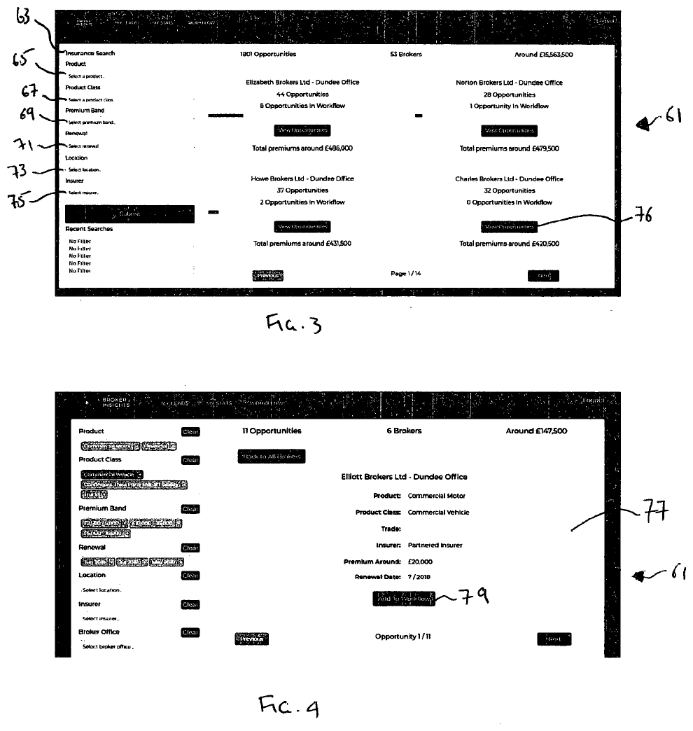

The ‘My Leads’ search facility 61 shown in FIG. 3 enables the partner insurers' business development managers (BDM) to search the database using key criteria 63 to identify possible business opportunities in the brokers for which the BDMs are responsible. The system will be configured to enable the identification of each BDM's brokers.

The search criteria 63 are Product, Product Class, Premium Band, Renewal (date ranges), Location, Insurer and Broker Office. Policy details such as the brokers' customer names or exact premium are removed from the data received by the system from the brokers during the ingestion process 37. The search facility shown in FIG. 3 allows the insurer to identify potential opportunities using a client id which the broker can cross reference to the specific insurer and policy when the BDM contacts the broker. In another example of the invention, detailed client information is automatically added to the query before it is received by the broker.

Search selections are as follows. BDMs can choose individual selection criteria or combinations of criteria.

The selection of a Product 65 will filter the Product Classes to those that are a sub-category of the Product.

Product Add On; Commercial Motor; Employee Benefits; Engineering; Financial; Marine; Liability; Professional Indemnity; Other Commercial Single Class; Package; High Net Worth; Property; Transit.

Product Class 67: There are over 100 product classes, which are sub-categories of the Products.

Premium Band 69: £1-£1000, £1001-£2500, £2501-£5000, £5001-£10000, £10001-£25000, £25001-£50000, £50001-£100000, £100000+.

Renewal 71: Selection made by month or combinations of months

Location 73: East Midlands, London, West Midlands, N Ireland, North East, North West, Scotland, South West, South East, Wales

Insurer 75: Search can be made on non-partner insurers.

A BDMs will search the system for potential business opportunities with the brokers for which they are responsible using one or more of the search criteria. Multiple products and product classes can be chosen for a single search. The opportunities are summarised in the boxes 77 on the right of the My Leads screen as shown in FIG. 4. Each box is associated with a single broker office. The BDM can then drill down to view more detail by clicking the ‘View Opportunities’ button 76 within the box as shown in FIG. 2. The BDM can store opportunities that they identify during the search and want to follow up by clicking the ‘Add to Workflow’ button 79.

FIG. 5 shows the workflow screen 81 of this example of the present invention. The workflow screen enables the BDMs to manage the opportunities that they have identified. They will follow up attractive opportunities by contacting the relevant broker directly to obtain more specific details, provide a quote etc. A note function may be included to enable BDMs to attach notes to opportunities to assist them with the management of the opportunity. The BDM can delete opportunities that they decide not to pursue. The opportunity will be removed 83 if the renewal date is passed, as it will no longer be relevant. The BDM will quote the ‘Client ID’ 85 given on the screen when contacting the relevant broker as this will enable the broker to identify the specific end customer and policy. This identification process is to protect the brokers' key business data i.e. customers and policies. In at least one example of the present invention, the Client ID shown to the insurer will be presented as full client details in the message received by the broker.

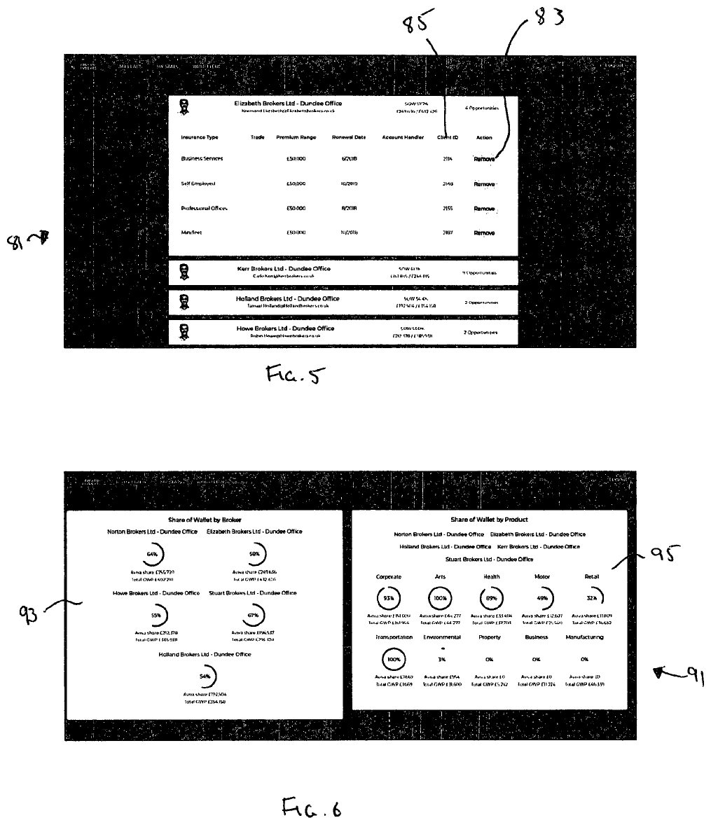

FIG. 6 shows the My Stats screen 91 which provides management information about the BDM's share of wallet by broker 93 and by product 95 to enable them to monitor growth and identify areas requiring focus. These metrics have been chosen as they are standard key performance indicators within the insurance industry. In the case of an individual BDM, the BDM will have a target of, for example, £1 million per month and will deal with a defined number of brokers in a set geographical area. When the BDM uses the present invention, the system will be set up to show data from the brokers with whom the BDM has a relationship.

Consequently, the BDM can conduct targeted and tailored searches to improve the chances of achieving the sales target. In addition, the BDM will most likely require access to the system on desktop/laptop, tablet and mobile device. As stated above data masking/obfuscation is critical to the credibility of the system of the present invention to prevent unauthorised access to confidential information.

Insurer senior managers will have access to the My Leads screen figure to be able to review potential opportunities across all brokers for which their BDMs are responsible. As well as giving them visibility of the potential business for their BDMs, it will also enable them to identify significant opportunities where they may want to be more involved, especially with key clients.

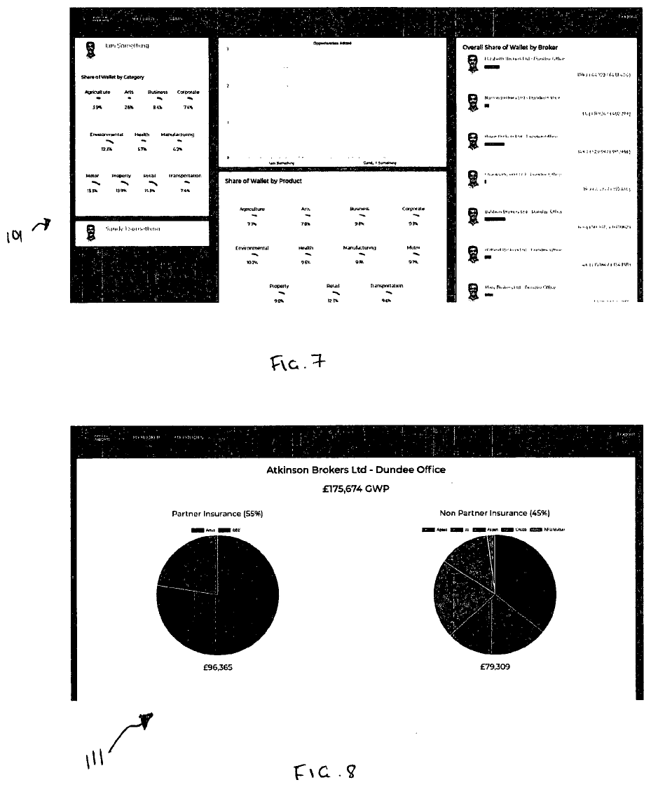

Additionally, the senior managers will have access a ‘Stats’ screen 101, FIG. 7 that can be used to monitor and manage BDMs' performance. A senior manager will have circa 12 BDM's who will report into her. Each BDM may have 50 brokers for his geographical area set. The senior manager may require to see the SOW (share of wallet) for the 12 BDM's 600 brokers in her region. She may also require to see this on an individual basis.

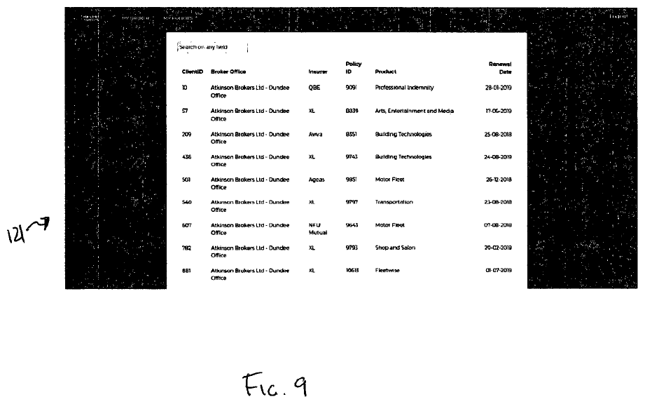

The brokers will have screens that provide them with a view of their portfolio ‘My Broker’ 111, FIG. 8 and a ‘My Policies’ 121, FIG. 9 will enable them to identify specific customers and policies when contacted by insurer BDMs who want to pursue a business opportunity.

The next management level may have 6 regional managers who report to and may be viewing the opportunity from 2400 brokers. At this level, the view most frequently used will be share of wallet by a product type. For example, marine insurance in the UK, the value and determining market share. In addition, a strategic view of areas where his business has high and low exposure. Markets where he needs to increase attention, or make sure they are receiving enough attention to grow.

At Director level, a view of SOW across the regional areas of the company will be required and there will be a requirement to monitor the effective use made of the system of the present invention.

In one or more example of the present invention, revenue is generated by a system in accordance with the present invention by charging a fee for using the system which may be levied monthly. The relevant charging information will be sent to the company's invoicing system to trigger the creation of insurers' invoices. In addition, a supplementary billing file in csv format will be created. This will contain policy level detail pertaining to the calculation of the invoice charges so that insurers can reconcile their invoices. As part of the account management of insurers, consultancy reports will be produced that will provide the insurers with insights into the risk profile and business composition of individual brokers and the broker using the present invention as a collective.

The fees to be paid to brokers will be calculated during the monthly billing run, and relevant billing information will be sent to the company's invoicing system to trigger the creation of brokers' bills. This will contain policy level detail pertaining to the calculation of the bill charges so that insurers can reconcile their fees that they are being paid.

A report will be produced every time a broker data file is received. This report will provide the broker with summary totals of key information (e.g. number of policies, total Gross Written Premium) to enable the broker to check that the correct data has been received. It will also provide details of any rejected information or inconsistencies so that the broker can review and correct any data issues. As part of the account management of brokers, consultancy reports will be produced that will provide the brokers with insights into their risk profile and business composition.

Reports will be produced to enable the company to manage all operational areas including finance, system performance and SLAs, business growth etc. Reporting for inclusion in the overall company board report packs will also be produced.

The business will provide insurers with a step change in Sales and Marketing capability through the aggregation of data and insight delivered through a user-friendly and effective technology platform. For brokers, it will provide all the benefits of scale with insurers as well as invaluable business management insight and support. The system of the present invention will markedly improve the quality, efficiency and effectiveness of the interactions between insurers and brokers.

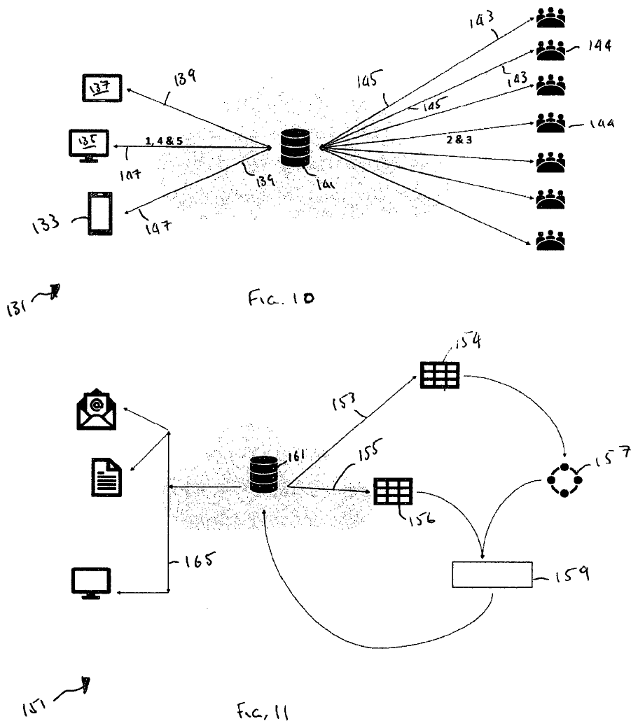

In another feature of the present invention as shown in FIG. 10, the system of the present invention provides insurers with the ability to target marketing data to brokers. This feature of the present invention provides partner insurers with the ability to target and tailor product and marketing messages specifically to the right person within broker offices based on the types of business they handle. This highly targeted and efficient marketing medium is very valuable to both brokers and insurers.

FIG. 10 shows a process 131 in which a number of insurers, in this case three, 133, 135, 137 use computing devices in two-way communication 139, 147 with the platform 141. The platform 141 is in two-way communication 143, 145 with one or more broker 144.

In use, an insurer representative 133 will Input a specific marketing message and optionally upload documentation 139. The insurer representative 133 can choose which broker representatives are contacted. It could be all representatives for general messages or representatives with specific areas of responsibility (e.g. motor insurance).

Messages are pushed to the chosen broker targets. The broker representatives can access any associated documentation that has been uploaded by the insurer as an option when logging into the platform. The broker representative can raise a request with the insurer (e.g. for more information or a call or meeting) by communication via the system 141. The insurer will receive any requests raised by broker representatives. Via the system 141 and management Information reports will be provided to insurers to enable them to monitor the success of campaigns.

In another feature of the present invention, software is provided which predictively matches insurers, brokers and customers. The software analyses various features of the interactions between the insurers, broker and customers such as the number of policies with specific insurers, transactional data and the behaviours within the platform to create a recommendation on which insurer products are of interest to specific brokers.

In one example the Broker will provide the following information.
Name
Location
Gross Written Premium
Types of policies

The Insurer will provide product information
Desired types of policies
Desired premium
Desired location
Stated benefits
Service location

The system of the present invention will use a rules-based software application such as a decision tree to match brokers and insurers. For example, if a broker has commercial motor policies worth £1.2K then we could recommend a list of products. These products would then be displayed on the platform to the broker user(s).

FIG. 11 is a schematic diagram which shows the predictive matching of brokers, insurers and customers. FIG. 11 shows a process 151 in which data is extracted 153, 155 from the platform 161 and categorised as data from partner insurers 154 and data from non-partner insurers 156. The partner data is grouped 157 and the groups are used 159 to find similar business on the platform 161 from other insurers. This information is then provided to the insurers 165.

In more detail, predictive matching is used to determine what policies are of interest to insurer.

In the first step, policy information is extracted 153, 155 from database and load into analysis environment 154, 156 as above for Policies with a partner insurer and Policies with a non-partner insurer

For the partner insurer data, groups are created based on factors such as premium value, product type, location. Potential to use Standard Industrial Classification (SIC) codes such as How: k-means, k-prototypes, HDBSCAN—unsupervised machine learning.

The data from the non-partner insurers is compared 159 against the groups that have just been formed and the distance/similarity to the groups determined.

The comparison information is stored in the platform database 161.

In the second step, recommendations 165 may be made to an insurer either statically in a report or email or could be displayed on the platform.

Another feature of the present invention is the ability to cross-sell multiple products.

For example, If a customers have shown interest in particular product combinations, the system of the present invention can illustrate this to brokers who have successfully promoted one product to a customer to suggest they also promote a suitable second product increasing sales.

The process will:
Extract customer and policy information from database in the platform;
Group the customers (e.g. by product, GWP, industry type etc);
Utilise Bayes statistics to calculate the probability of buying an additional policy given that they are in that group. P(A|B); and
Analyse the book that is held by the broker to determine if any customers that they have access to are likely to buy additional products.
Display this on the platform to the broker users.

If brokers have shown interest in particular product combinations, the system of the present invention can illustrate this to insurers who have successfully promoted one product to a broker to suggest that they also promote a suitable second product increasing sales.

The process will be, for each insurer:
Identify the customers that have policies with them;
Compare this to the rest of the customer base on the platform;
Find similar customers;
Look to see if they bought any other polices; and
Send a message to the insurer saying,
   “customer x bought y. Based on similar customers on the platform” we think that they might be willing to buy z″,
   Contact details for the broker.

The present invention is founded on the analysis of individual broker's customer data for their use, and the aggregation of that data to provide insight into the market for insurers. This will enable Broker Insights to provide:

Insight led insurer broker distribution and sales partnership; and

Insight led broker business management and placement partnership.

The invention will drive digital efficiency to a traditional marketplace where significant customer interaction and advice is required to understand and satisfy customer needs.

The introduction of a data aggregation service from brokers to insurers will provide insurers with greater clarity of available business enabling:
more accurate growth planning and opportunity identification;
more efficient sales and servicing;
increased visibility of business risk; and
increased visibility of business development opportunities.

In parallel the service will provide brokers with:
increased profits;
support for regulatory compliance;
more efficient sales interaction with insurers;
increased visibility of business risk; and
increased visibility of business development opportunities.

Improvements and modifications may be incorporated herein without deviating from the scope of the invention.

1. A computer implemented method for providing information to an end user, the method comprising the steps:
securely receiving agent data from an agent system;
aggregating the agent data into one or more database entry, the agent data comprising agent client data and agent identification data wherein agent client data is masked such that specific agent client data is absent from or obscured in the database entry;
Providing the database entry to a user interface of a user database.

2. The computer implemented method as claimed in claim 1 wherein, the system further comprises a communication means to allow communication from the user to the agent system.

3. The computer implemented method as claimed in claim 1 wherein, the communications means comprises a feature on the user interface which is actionable by the user to create a message to the agent.

4. The computer implemented method as claimed in claim 1 wherein, the message is a text message, multimedia message, email or the like.

5. The computer implemented method as claimed in claim 1 wherein, the agent is an insurance broker.

6. The computer implemented method as claimed in claim 1 wherein, the client is a customer of the insurance broker.

7. The computer implemented method as claimed in claim 1 wherein, the user is an insurer.

8. The computer implemented method as claimed in claim 1 wherein, the agent system is an insurance broker's customer management system.

9. The computer implemented method as claimed in claim 1 wherein, the agent client data comprises a database entry per agent client matter.

10. The computer implemented method as claim 1 wherein, the agent client data is masked by retaining agent identification data is retained in the data ingestion system.

11. The computer implemented method as claimed in claim 10 wherein, the data ingestion system standardizes the agent data.

12. The computer implemented method as claimed in claim 10 wherein, the data ingestion system logs agent client data received so as to separately identify the agent client matters contained in the agent client data.

13. The computer implemented method as claimed in claims 10 wherein, the data ingestion process records changes to the database which occur during data ingestion. The result of the ongoing ingestion of data files is the aggregated data in the database.

14. The computer implemented method as claimed in claim 1 wherein, the agent data is received as encrypted data.

15. The computer implemented method as claimed in claim 1 wherein, the agent data is received upon the action of a data verification step initiated by the agent system

16. The computer implemented method as claimed in claim 1 wherein, the user database comprises a MySQL relational database.

17. The computer implemented method as claimed claim 1 wherein, the system further comprises a secondary database which is a mirror image of the primary database.

18. The computer implemented method as claimed in claim 1 wherein, the secondary database reflects any changes to the primary database due to data ingestion or user input.

19. The computer implemented method as claimed in claim 1 wherein, the user interface comprises a plurality of selectable data views.

20. The computer implemented method as claimed in claim 1 wherein, the user interface is configured to be viewable on a mobile computing device such as a smartphone.

21. The computer implemented method as claimed in preceding claim 1 wherein, the user interface is configured to be viewable on a tablet computing device.

22. The computer implemented method as claimed in claim 1 wherein, the user interface is configured to be viewable on a laptop or desktop computer.

23. A computer implemented method as claimed in claim 1 wherein a marketing information is uploadable to the system by one or more agent and the user may select can choose an agent based upon the message content wherein said marketing information is pushed to chosen user targets.

24. A computer implemented method as claimed in claim 1 wherein the system further comprises a predictive software application which matches agents with users based on one or more criteria.

25. A computer implemented method as claimed in claim 24 wherein the predictive software application extracts policy information from one or more database entry; separates the information into policy information from partner agents and non-partner agents, categorises the partner agent policy information based on a range of criteria; compares the categorised partner agent information with the non-partner information to determine the similarity between the partner information and the non-partner information.
